(19) United States
(12) Patent Application Publication
(10) Pub. No.: US 2015/0234523 A1
(43) Pub. Date: Aug. 20, 2015

(54) TOUCH PANEL AND DISPLAY APPARATUS

(71) Applicant: SHENZHEN CHINA STAR OPTOELECTRONICS TECHNOLOGY CO., LTD., Guangdong (CN)

(72) Inventor: Ruhai Fu, Guangdong (CN)

(73) Assignee: SHENZHEN CHINA STAR OPTOELECTRONICS TECHNOLOGY CO., LTD., Guangdong (CN)

(21) Appl. No.: 14/356,189

(22) PCT Filed: Mar. 13, 2014
(86) PCT No.: PCT/CN2014/072364

§ 371 Date: May 5, 2014

(30) Foreign Application Priority Data
Feb. 19, 2014 (CN) 201410056709.3

(51) Int. Cl. G06F 3/041

(52) U.S. Cl. CPC G06F 3/0416; G06F 3/0412

(57) ABSTRACT

A touch panel and a display apparatus are provided. The touch panel comprises at least two position detecting zones arranged in a matrix manner, wherein each of the position detecting zones comprises a first touch sensing unit assembly having a first touch sensing unit and a second touch sensing unit, and a second touch sensing unit assembly having a third touch sensing unit and a fourth touch sensing unit. A first connection line between the first and second touch sensing units is parallel to a second connection line between the third and fourth touch sensing units, and the first touch sensing unit assemblies and the second touch sensing unit assemblies are arranged as a dislocation arrangement.

### FIELD OF THE INVENTION

The present invention relates to a display technology, and more particularly to a touch panel and a display apparatus.

### BACKGROUND OF THE INVENTION

As shown in FIG. 1, in a conventional single-layer touch panel, all driving lines 101 are disposed at one side of the detection lines 102 for multiple touching in a single layer.

In practice, there are some problems in the conventional technology, as described below.

As shown in FIG. 1, since ITO electrodes in the conventional single-layer touch panel have a greater impedance, the driving lines 101 cannot be too thin. That is, the driving lines 101 have a greater width, resulting in a greater area of the driving lines 101 in the single-layer touch panel. Therefore, as shown in FIG. 2, the area of the touch active zones 201 is reduced, and the area of the touch blind zones 202 is increased.

The touch blind zones 202 will result in large deviations in a weight calculation of a position detection for detecting touch positions. When a touch object moves from a touch sensing unit to another touch sensing unit, due to the wider zones 202, the touch object cannot cover the touch sensing unit and another touch sensing unit at the same time. At this time, a smooth transition cannot be achieved by the weight calculation, and it easily occurs that the previous touch sensing unit is detected as a touch position point in the position detection. As shown in FIG. 3, in a movement path 301 of the touch object, more position points can be determined by the conventional single-layer touch panel when the touch object is positioned in the touch active zones 201, and less position points are determined by the conventional single-layer touch panel when the touch object is positioned in the touch blind zones 202. Therefore, a smooth transition in the movement path 301 between the touch active zones 201 and the touch blind zones 202 cannot be achieved.

Accordingly, as shown in FIG. 4, the touch position detection in the conventional single-layer touch panel will have larger linear fluctuations.

As a result, it is necessary to provide a new technology to solve the problems existing in the conventional technologies, as described above.

### SUMMARY OF THE INVENTION

The present invention provides a touch panel and a display apparatus for a reduced touch blind zone and a mitigated linear fluctuation.

A primary object of the present invention is to provide a touch panel, and the touch panel comprises: at least two position detecting zones arranged in a matrix manner, wherein each of the position detecting zones comprises a first touch sensing unit assembly comprising a first touch sensing unit and a second touch sensing unit; and a second touch sensing unit assembly comprising a third touch sensing unit and a fourth touch sensing unit. A first connection line between the first touch sensing unit and the second touch sensing unit is parallel to a second connection line between the third touch sensing unit and the fourth touch sensing unit, and the first touch sensing unit assemblies and the second touch sensing unit assemblies are arranged as a dislocation arrangement, and an edge of the third touch sensing unit is connected to at least one of the first touch sensing unit and the second touch sensing unit, and the first touch sensing unit assemblies and the second touch sensing unit assemblies are fitted to each other.

In the above-mentioned touch panel, the first touch sensing unit, the second touch sensing unit, the third touch sensing unit, and the fourth touch sensing unit are arranged as a parallelogram array, and four vertices of a parallelogram corresponding to the parallelogram array are formed by ends of the first touch sensing unit, the second touch sensing unit, the third touch sensing unit, and the fourth touch sensing unit, and an interior angle of the parallelogram is less than or greater than 90 degrees.

In the above-mentioned touch panel, there is a first interval between the first touch sensing unit and the second touch sensing unit, and the third touch sensing unit is partially overlapped with the first interval.

In the above-mentioned touch panel, each of the first touch sensing unit, the second touch sensing unit, the third touch sensing unit, and the fourth touch sensing unit comprises at least one driving line and a sensing line, and the driving line and the sensing line are positioned on the same layer.

In the above-mentioned touch panel, the driving line and the sensing line of the first touch sensing unit, the second touch sensing unit, the third touch sensing unit, and the fourth touch sensing unit comprise a first electrode array and a second electrode array, respectively, and the first electrode array and second electrode array comprise at least two elongated electrodes, and the first electrode array and second electrode array are fitted to each other.

Another object of the present invention is to provide a touch panel, and the touch panel comprises: at least two position detecting zones arranged in a matrix manner, wherein each of the position detecting zones comprises a first touch sensing unit assembly comprising a first touch sensing unit and a second touch sensing unit; and a second touch sensing unit assembly comprising a third touch sensing unit and a fourth touch sensing unit. A first connection line between the first touch sensing unit and the second touch sensing unit is parallel to a second connection line between the third touch sensing unit and the fourth touch sensing unit, and the first touch sensing unit assemblies and the second touch sensing unit assemblies are arranged as a dislocation arrangement.

In the above-mentioned touch panel, the first touch sensing unit, the second touch sensing unit, the third touch sensing unit, and the fourth touch sensing unit are arranged as a parallelogram array, and four vertices of a parallelogram corresponding to the parallelogram array are formed by ends of the first touch sensing unit, the second touch sensing unit, the third touch sensing unit, and the fourth touch sensing unit, and an interior angle of the parallelogram is less than or greater than 90 degrees.

In the above-mentioned touch panel, there is a first interval between the first touch sensing unit and the second touch sensing unit, and the third touch sensing unit is partially overlapped with the first interval.

In the above-mentioned touch panel, an edge of the third touch sensing unit is connected to at least one of the first touch sensing unit and the second touch sensing unit.

In the above-mentioned touch panel, each of the first touch sensing unit, the second touch sensing unit, the third touch sensing unit, and the fourth touch sensing unit comprises at least one driving line and a sensing line, and the driving line and the sensing line are positioned on the same layer.

In the above-mentioned touch panel, the driving line and the sensing line of the first touch sensing unit, the second touch sensing unit, the third touch sensing unit, and the fourth touch sensing unit comprise a first electrode array and a second electrode array, respectively, and the first electrode array and second electrode array comprise at least two elongated electrodes, and the first electrode array and second electrode array are fitted to each other.

In the above-mentioned touch panel, the first touch sensing unit assemblies and the second touch sensing unit assemblies are fitted to each other.

Still another object of the present invention is to provide a display apparatus, and the touch display apparatus comprises a display device and a touch panel, wherein the touch panel comprises: at least two position detecting zones arranged in a matrix manner, wherein each of the position detecting zones comprises a first touch sensing unit assembly comprising a first touch sensing unit and a second touch sensing unit, and a second touch sensing unit assembly comprising a third touch sensing unit and a fourth touch sensing unit. A first connection line between the first touch sensing unit and the second touch sensing unit is parallel to a second connection line between the third touch sensing unit and the fourth touch sensing unit, and the first touch sensing unit assemblies and the second touch sensing unit assemblies are arranged as a dislocation arrangement.

In the above-mentioned display apparatus, the first touch sensing unit, the second touch sensing unit, the third touch sensing unit, and the fourth touch sensing unit are arranged as a parallelogram array, and four vertices of a parallelogram corresponding to the parallelogram array are formed by ends of the first touch sensing unit, the second touch sensing unit, the third touch sensing unit, and the fourth touch sensing unit, and an interior angle of the parallelogram is less than or greater than 90 degrees.

In the above-mentioned display apparatus, there is a first interval between the first touch sensing unit and the second touch sensing unit, and the third touch sensing unit is partially overlapped with the first interval.

In the above-mentioned display apparatus, an edge of the third touch sensing unit is connected to at least one of the first touch sensing unit and the second touch sensing unit.

In the above-mentioned display apparatus, each of the first touch sensing unit, the second touch sensing unit, the third touch sensing unit, and the fourth touch sensing unit comprises at least one driving line and a sensing line, and the driving line and the sensing line are positioned on the same layer.

In the above-mentioned display apparatus, the driving line and the sensing line of the first touch sensing unit, the second touch sensing unit, the third touch sensing unit, and the fourth touch sensing unit comprise a first electrode array and a second electrode array, respectively, and the first electrode array and second electrode array comprise at least two elongated electrodes, and the first electrode array and second electrode array are fitted to each other.

In the above-mentioned display apparatus, the first touch sensing unit assemblies and the second touch sensing unit assemblies are fitted to each other.

In comparison with the conventional technology, the touch panel and the display apparatus on the present invention have a reduced area of the touch blind zones, thereby mitigating the linear fluctuations of the touch panel during touch sensing.

The structure and the technical means adopted by the present invention to achieve the above and other objects can be best understood by referring to the following detailed description of the preferred embodiments and the accompanying drawings.

### DESCRIPTION OF THE DRAWINGS

FIG. 1 is a partially schematic diagram showing a conventional single-layer touch panel;

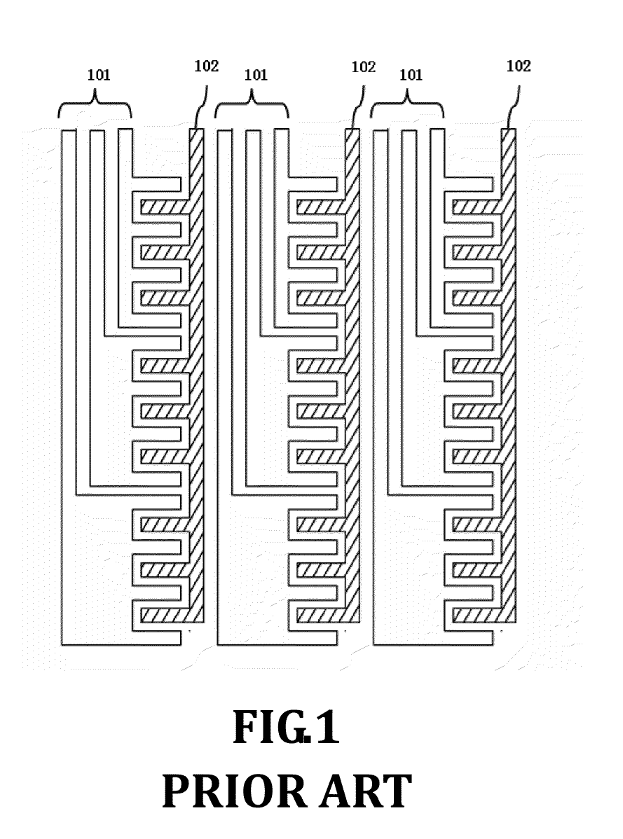

FIG. 2 is a diagram showing touch active zones and blind zones of the single-layer touch panel shown in FIG. 1;

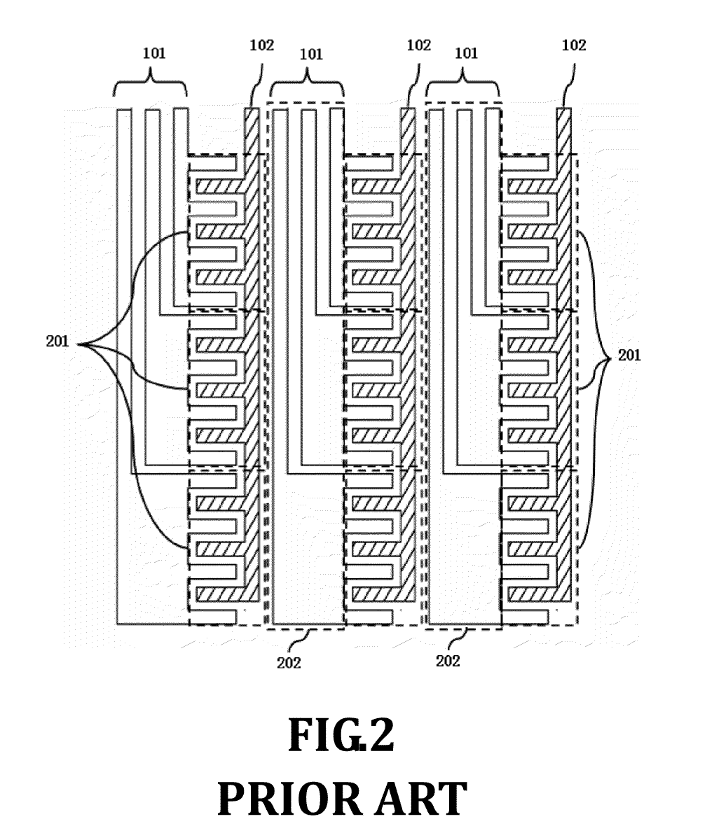

FIG. 3 is a diagram showing position points of a touch object positioned in the touch active zones shown in FIG. 1;

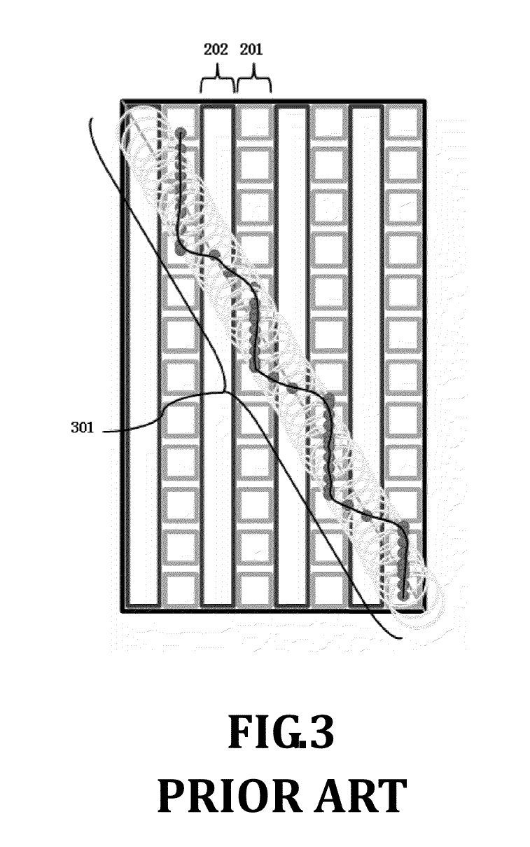

FIG. 4 is a diagram showing linear fluctuations corresponding to the position points shown in FIG. 3;

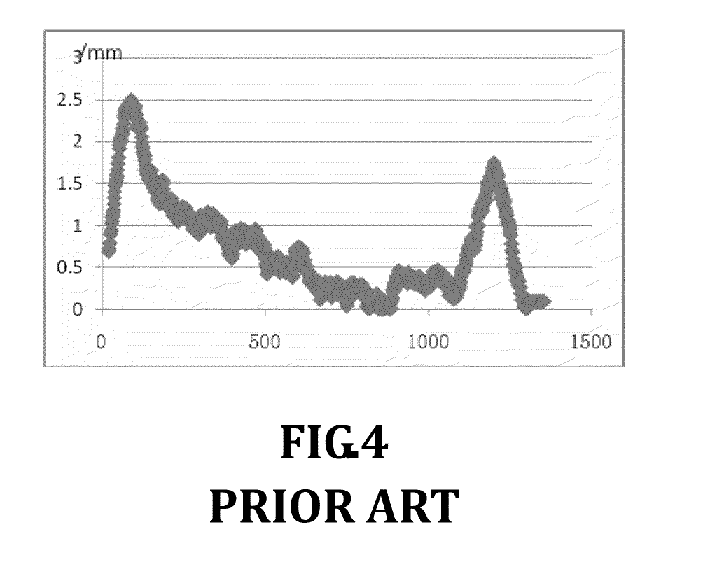

FIG. 5 is a diagram showing a positioning range of four adjacent touch active zones shown in FIG. 3;

FIG. 6 is a schematic diagram showing a touch panel according to a first embodiment of the present invention;

FIG. 7 is a diagram showing a positioning range of position detecting zones shown in FIG. 6;

FIG. 8 is a schematic diagram showing a touch panel according to a second embodiment of the present invention; and

FIG. 9 is a schematic diagram showing a touch panel according to a third embodiment of the present invention.

### DETAILED DESCRIPTION OF THE PREFERRED EMBODIMENTS

The following embodiments are referring to the accompanying drawings for exemplifying specific implementable embodiments of the present invention.

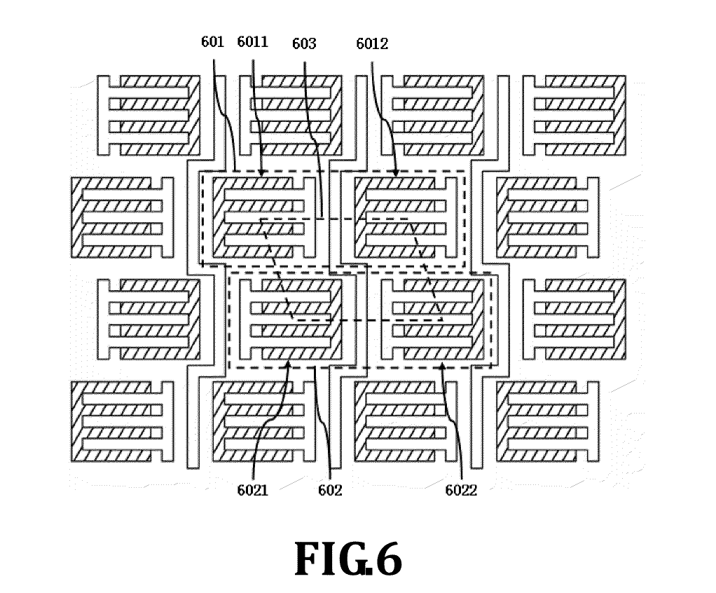

FIG. 6 is a schematic diagram showing a touch panel according to a first embodiment of the present invention.

The touch panel of this embodiment comprises a position detecting zone array, wherein the position detecting zone array comprises at least two position detecting zones. That is, the touch panel comprises at least two position detecting zones, and the at least two position detecting zones are arranged in a matrix manner. Each of the position detecting zones comprises a first touch sensing unit assembly 601 and a second touch sensing unit assembly 602, wherein the first touch sensing unit assembly 601 comprises a first touch sensing unit 6011 and a second touch sensing unit 6012, and second touch sensing unit assembly 602 comprises a third touch sensing unit 6021 and a fourth touch sensing unit 6022.

A first connection line between the first touch sensing unit 6011 and the second touch sensing unit 6012 is parallel to a second connection line between the third touch sensing unit 6021 and the fourth touch sensing unit 6022. The first touch sensing unit assemblies 601 and the second touch sensing unit assemblies 602 are arranged as a dislocation arrangement. Specifically, the first touch sensing unit 6011, the second touch sensing unit 6012, the third touch sensing unit 6021 and the fourth touch sensing unit 6022 can be arranged as a parallelogram array 603. Four vertices of a parallelogram corresponding to the parallelogram array 603 are formed by ends of the first touch sensing unit 6011, the second touch sensing unit 6012, the third touch sensing unit 6021, and the fourth touch sensing unit 6022. In this case, any interior angle of the parallelogram is less than or greater than 90 degrees. That is, the interior angle is any angle other than a right angle, and the parallelogram corresponding to the parallelogram array 603 is not a rectangle.

As mentioned above, the first touch sensing unit assemblies 601 and the second touch sensing unit assemblies 602 are arranged as a dislocation arrangement, and a length of a diagonal line of the parallelogram formed by the first touch sensing unit assemblies 601 and the second touch sensing unit assemblies 602 is reduced. That is, a distance between the first touch sensing unit 6011 and the third touch sensing unit 6021 is decreased for reducing an area of the touch blind zones, thereby mitigating the linear fluctuations of the touch panel during touch sensing.

In addition, a distance between the second touch sensing unit 6012 and the fourth touch sensing unit 6022 is increased. However, since distance between the first touch sensing unit 6011 and the third touch sensing unit 6021 is decreased, positions of a touch object can be more easily detected by the first touch sensing unit 6011 and the third touch sensing unit 6021. Moreover, the positions of the touch object can be more efficiently detected by the first touch sensing unit 6011, the third touch sensing unit 6021, and one of the second touch sensing unit 6012 and the fourth touch sensing unit 6022.

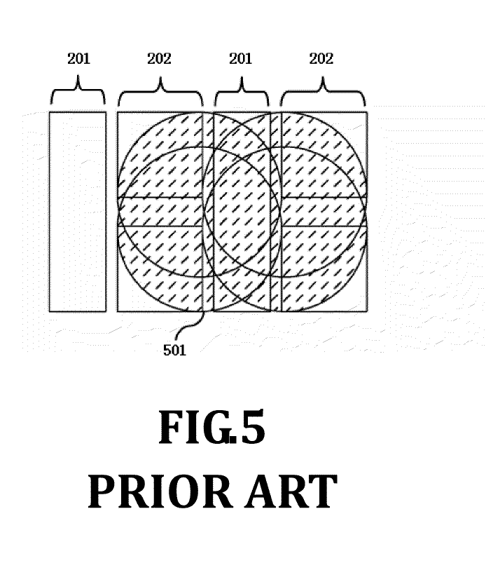

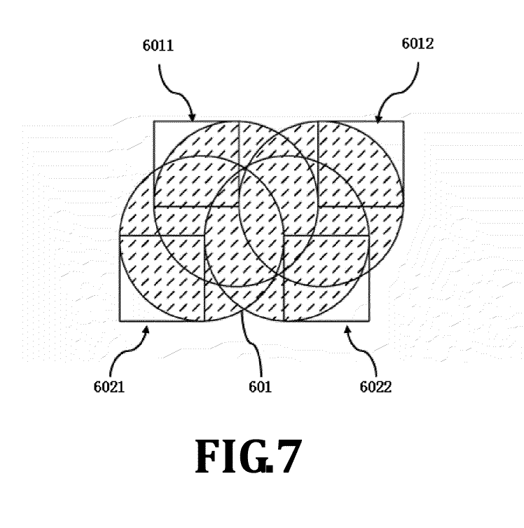

In this embodiment, the first touch sensing unit assemblies 601 and the second touch sensing unit assemblies 602 are arranged as the dislocation arrangement. Therefore, the positions of the touch object can be efficiently overlapped and detected by any three of the first touch sensing unit 6011, the second touch sensing unit 6012, the third touch sensing unit 6021, and the fourth touch sensing unit 6022. In this embodiment, a positioning range of the position detecting zone (comprising the first touch sensing unit 6011, the second touch sensing unit 6012, the third touch sensing unit 6021, and the fourth touch sensing unit 6022) is a shaded area shown in FIG. 7. The shaded area is formed by four circular areas which are overlapped with each other, and each of the circular areas can partially cover any three of the first touch sensing unit 6011, the second touch sensing unit 6012, the third touch sensing unit 6021, and the fourth touch sensing unit 6022. In comparison with a shaded area in FIG. 5, the positioning range (shaded area 601 in FIG. 7) of the touch panel of the present invention is larger than a positioning range (shaded area 501) of a conventional touch panel.

In an improved embodiment, an edge of the third touch sensing unit 6021 is connected to at least one of the first touch sensing unit 6011 and the second touch sensing unit 6012.

In the present embodiment, each of the first touch sensing unit 6011, the second touch sensing unit 6012, the third touch sensing unit 6021, and the fourth touch sensing unit 6022 comprises at least one driving line and a sensing line, and the driving line and the sensing line are positioned on the same layer. The material of the driving line and a sensing line can be ITO, metal mesh or graphene.

In the present embodiment, the first touch sensing unit 6011, the second touch sensing unit 6012, the third touch sensing unit 6021, and the fourth touch sensing unit 6022 each have the same shape, such as a rectangle, a rhombus, a circle, or a triangle.

Preferably, each of the first touch sensing unit 6011, the second touch sensing unit 6012, the third touch sensing unit 6021, and the fourth touch sensing unit 6022 includes saw-toothed portions corresponding to each other. Specifically, the driving line and the sensing line of the first touch sensing unit 6011, the second touch sensing unit 6012, the third touch sensing unit 6021, and the fourth touch sensing unit 6022 comprise a first electrode array and a second electrode array, respectively. The first electrode array and second electrode array comprise at least two elongated electrodes, and the first electrode array and second electrode array are fitted to each other.

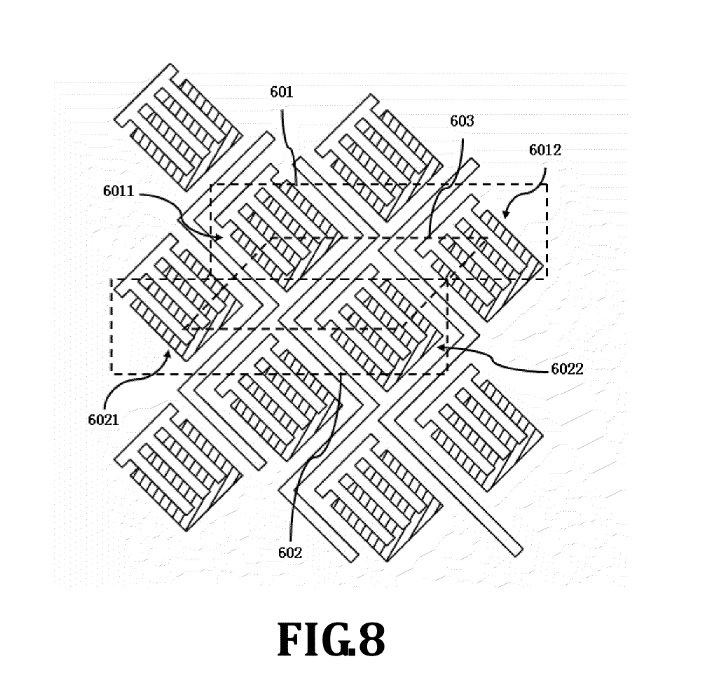

FIG. 8 is a schematic diagram showing a touch panel according to a second embodiment of the present invention. This embodiment is similar to the first embodiment, and the differences there-between are described below.

In this embodiment, the first touch sensing unit 6011, the second touch sensing unit 6012, the third touch sensing unit 6021, and the fourth touch sensing unit 6022 are in a rhombic shape. The first touch sensing unit assemblies 601 and the second touch sensing unit assemblies 602 are fitted to each other. Specifically, in this embodiment, there is a first interval between the first touch sensing unit 6011 and the second touch sensing unit 6012, and the third touch sensing unit 6021 is partially overlapped with the first interval. That is, a portion of the third touch sensing unit 6021 is positioned in the first interval.

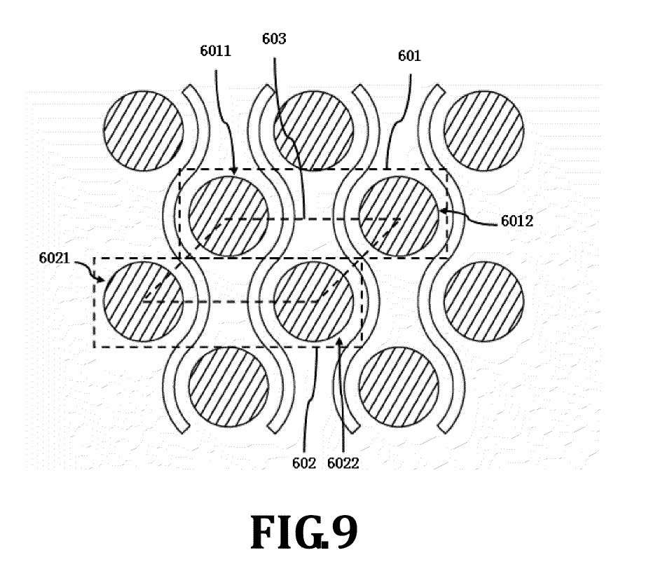

FIG. 9 is a schematic diagram showing a touch panel according to a third embodiment of the present invention. This embodiment is similar to the first or second embodiment, and the differences there-between are described below.

In this embodiment, the first touch sensing unit 6011, the second touch sensing unit 6012, the third touch sensing unit 6021, and the fourth touch sensing unit 6022 are in a circular or elliptical shape. In this case, the first touch sensing unit 6011, the second touch sensing unit 6012, the third touch sensing unit 6021, and the fourth touch sensing unit 6022 do not include saw-toothed portions.

The display apparatus of the present invention comprises a display device and the above-mentioned touch panel. In this case, the display device may be a display panel, such as liquid crystal display (LCD) panel, and the touch panel can be disposed on the display device for sensing positions of the touch object. The touch panel and the display device can be assembled as one piece. That is, the display device can be embedded in the display device. For example, the display device may be an organic light emitting diode (OLED) display.

The present invention has been described with preferred embodiments thereof and it is understood that many changes and modifications to the described embodiment can be carried out without departing from the scope and the spirit of the invention that is intended to be limited only by the appended claims.

1. A touch panel, comprising:
at least two position detecting zones arranged in a matrix manner, wherein each of the position detecting zones comprises:
a first touch sensing unit assembly comprising a first touch sensing unit and a second touch sensing unit; and
a second touch sensing unit assembly comprising a third touch sensing unit and a fourth touch sensing unit;
wherein a first connection line between the first touch sensing unit and the second touch sensing unit is parallel to a second connection line between the third touch sensing unit and the fourth touch sensing unit, and the first touch sensing unit assemblies and the second touch sensing unit assemblies are arranged as a dislocation arrangement;
wherein an edge of the third touch sensing unit is connected to at least one of the first touch sensing unit and the second touch sensing unit;
wherein the first touch sensing unit assemblies and the second touch sensing unit assemblies are fitted to each other.

2. The touch panel according to claim 1, wherein the first touch sensing unit, the second touch sensing unit, the third touch sensing unit, and the fourth touch sensing unit are arranged as a parallelogram array, and four vertices of a parallelogram corresponding to the parallelogram array are formed by ends of the first touch sensing unit, the second touch sensing unit, the third touch sensing unit, and the fourth touch sensing unit, and an interior angle of the parallelogram is less than or greater than 90 degrees.

3. The touch panel according to claim 1, wherein there is a first interval between the first touch sensing unit and the second touch sensing unit, and the third touch sensing unit is partially overlapped with the first interval.

4. The touch panel according to claim 1, wherein each of the first touch sensing unit, the second touch sensing unit, the third touch sensing unit, and the fourth touch sensing unit comprises at least one driving line and a sensing line, and the driving line and the sensing line are positioned on the same layer.

5. The touch panel according to claim 4, wherein the driving line and the sensing line of the first touch sensing unit, the second touch sensing unit, the third touch sensing unit, and the fourth touch sensing unit comprise a first electrode array and a second electrode array, respectively, and the first electrode array and second electrode array comprise at least two elongated electrodes, and the first electrode array and second electrode array are fitted to each other.

6. A touch panel, comprising:
at least two position detecting zones arranged in a matrix manner, wherein each of the position detecting zones comprises:
a first touch sensing unit assembly comprising a first touch sensing unit and a second touch sensing unit; and
a second touch sensing unit assembly comprising a third touch sensing unit and a fourth touch sensing unit;
wherein a first connection line between the first touch sensing unit and the second touch sensing unit is parallel to a second connection line between the third touch sensing unit and the fourth touch sensing unit, and the first touch sensing unit assemblies and the second touch sensing unit assemblies are arranged as a dislocation arrangement.

7. The touch panel according to claim 6, wherein the first touch sensing unit, the second touch sensing unit, the third touch sensing unit, and the fourth touch sensing unit are arranged as a parallelogram array, and four vertices of a parallelogram corresponding to the parallelogram array are formed by ends of the first touch sensing unit, the second touch sensing unit, the third touch sensing unit, and the fourth touch sensing unit, and an interior angle of the parallelogram is less than or greater than 90 degrees.

8. The touch panel according to claim 6, wherein there is a first interval between the first touch sensing unit and the second touch sensing unit, and the third touch sensing unit is partially overlapped with the first interval.

9. The touch panel according to claim 6, wherein an edge of the third touch sensing unit is connected to at least one of the first touch sensing unit and the second touch sensing unit.

10. The touch panel according to claim 6, wherein each of the first touch sensing unit, the second touch sensing unit, the third touch sensing unit, and the fourth touch sensing unit comprises at least one driving line and a sensing line, and the driving line and the sensing line are positioned on the same layer.

11. The touch panel according to claim 10, wherein the driving line and the sensing line of the first touch sensing unit, the second touch sensing unit, the third touch sensing unit, and the fourth touch sensing unit comprise a first electrode array and a second electrode array, respectively, and the first electrode array and second electrode array comprise at least two elongated electrodes, and the first electrode array and second electrode array are fitted to each other.

12. The touch panel according to claim 6, wherein the first touch sensing unit assemblies and the second touch sensing unit assemblies are fitted to each other.

13. A display apparatus, comprising a display device and a touch panel, wherein the touch panel comprises:
at least two position detecting zones arranged in a matrix manner, wherein each of the position detecting zones comprises:
a first touch sensing unit assembly comprising a first touch sensing unit and a second touch sensing unit; and
a second touch sensing unit assembly comprising a third touch sensing unit and a fourth touch sensing unit;
wherein a first connection line between the first touch sensing unit and the second touch sensing unit is parallel to a second connection line between the third touch sensing unit and the fourth touch sensing unit, and the first touch sensing unit assemblies and the second touch sensing unit assemblies are arranged as a dislocation arrangement.

14. The display apparatus according to claim 13, wherein the first touch sensing unit, the second touch sensing unit, the third touch sensing unit and the fourth touch sensing unit are arranged as a parallelogram array, and four vertices of a parallelogram corresponding to the parallelogram array are formed by ends of the first touch sensing unit, the second touch sensing unit, the third touch sensing unit, and the fourth touch sensing unit, and an interior angle of the parallelogram is less than or greater than 90 degrees.

15. The display apparatus according to claim 13, wherein there is a first interval between the first touch sensing unit and the second touch sensing unit, and the third touch sensing unit is partially overlapped with the first interval.

16. The display apparatus according to claim 13, wherein an edge of the third touch sensing unit is connected to at least one of the first touch sensing unit and the second touch sensing unit.

17. The display apparatus according to claim 13, wherein each of the first touch sensing unit, the second touch sensing unit, the third touch sensing unit, and the fourth touch sensing unit comprises at least one driving line and a sensing line, and the driving line and the sensing line are positioned on the same layer.

18. The display apparatus according to claim 17, wherein the driving line and the sensing line of the first touch sensing unit, the second touch sensing unit, the third touch sensing unit, and the fourth touch sensing unit comprise a first electrode array and a second electrode array, respectively, and the first electrode array and second electrode array comprise at least two elongated electrodes, and the first electrode array and second electrode array are fitted to each other.

19. The display apparatus according to claim 13, wherein the first touch sensing unit assemblies and the second touch sensing unit assemblies are fitted to each other.
